(19) United States
(12) Patent Application Publication
(10) Pub. No.: US 2022/0319451 A1
(43) Pub. Date: Oct. 6, 2022

(54) BACKLIGHT MODULE AND DISPLAY DEVICE HAVING SAME

(71) Applicant: Shenzhen China Star Optoelectronics Semiconductor Display Technology Co., Ltd., Shenzhen, Guangdong (CN)

(72) Inventors: Xingyi LIU, Shenzhen, Guangdong (CN); Wenlin MEI, Shenzhen, Guangdong (CN); Sikun HAO, Shenzhen, Guangdong (CN)

(73) Assignee: Shenzhen China Star Optoelectronics Semiconductor Display Technology Co., Ltd., Shenzhen, Guangdong (CN)

(21) Appl. No.: 17/252,310

(22) PCT Filed: Nov. 19, 2020
(86) PCT No.: PCT/CN2020/129950

§ 371 Date: Dec. 15, 2020

(30) Foreign Application Priority Data
Sep. 1, 2020 (CN) 202010905373.9

(51) Int. Cl. G09G 3/34; G02F 1/13357

(52) U.S. Cl. CPC G09G 3/3426; G02F 1/133603

(57) ABSTRACT

A backlight module and a display device having same are disclosed. The backlight module comprises a plurality of backplanes that are combined. A plurality of light emitting units are disposed on the backplane for emitting light under control of power source high potential signals and power source low potential signals. The light emitting units include first light emitting units that are located in a combining area of adjacent backplanes and second light emitting units that are located in other areas of the backplanes. On at least one of the backplanes, intensity of first power source high potential signals corresponding to the first light emitting units is greater than that of second power source high potential signals corresponding to the second light emitting units.

### FIELD OF INVENTION

The present disclosure relates to display technology, and especially relates to a backlight module and a display device having same.

### BACKGROUND OF INVENTION

Mini-light emitting diode (Mini-LED) backlights have been widely applied and used as backlights of liquid crystal display (LCD) panel because of their characteristics, such as small sizes, capability of achieving super-thin backlights, and capability of achieving multi-partition driving. Mini-LED backlight modules applied for conventional large-size displays are usually formed by combining multiple backplanes. However, because intervals between mini-LEDs located in combining areas between the adjacent backplanes are larger than intervals between the mini-LEDs located in inner areas of the backplanes, an overall brightness of the combining area is lower than an overall brightness of the inner areas. Therefore, display effect is affected.

Therefore, in the conventional mini-LED backlight modules, there is a technical problem of having lower brightness in the combining areas. The technical problem needs to be overcome.

### SUMMARY OF INVENTION

### Technical Problem

The present disclosure provides a backlight module and a display device having same for overcoming a technical problem of having lower brightness in combining areas in conventional mini-LED backlight modules.

### Technical Solution

To solve the aforementioned problem, the present disclosure provides a technical solution which is as described hereinbelow:

The present disclosure provides a backlight module, comprising a plurality of backplanes that are combined; wherein a plurality of light emitting units are disposed on the backplane in an array, the light emitting units are configured for emitting light under control of power source high potential signals and power source low potential signals; wherein the light emitting units include first light emitting units that are located in a combining area of adjacent backplanes and second light emitting units that are located in other areas of the backplanes; wherein on at least one of the backplanes, intensity of first power source high potential signals corresponding to the first light emitting units is greater than that of second power source high potential signals corresponding to the second light emitting units.

In the backlight module of the present disclosure, for two adjacent backplanes, the intensity of the first power source high potential signals, corresponding to any one of the backplanes is greater than that of the second power source high potential signals corresponding to the same backplane.

In the backlight module of the present disclosure, the intensity of the first power source high potential signals corresponding to the two backplanes, respectively, are equal.

In the backlight module of the present disclosure, for two adjacent backplanes, the intensity of the first power source high potential signals corresponding to one of the two backplanes is greater than that of the second power source high potential signals corresponding to the same backplane, and the intensity of first power source high potential signals corresponding to the other backplane is equal to that of the second power source high potential signals corresponding to the same backplane.

In the backlight module of the present disclosure, on the backplanes, a same row of light emitting units are connected to a same power source high potential signal wire that inputs the same power source high potential signals to every light emitting unit of the corresponding row.

In the backlight module of the present disclosure, on the backplanes, the intensity of the power source low potential signals corresponding to each of the light emitting units, respectively, are equal.

In the backlight module of the present disclosure, the plurality of backplanes are each connected with a corresponding driving chip that input the first power source high potential signals and the second power source high potential signals to the light emitting units.

In the backlight module of the present disclosure, the driving chip is configured for querying a corresponding voltage compensation value from a locally stored voltage compensation comparison table according to a brightness difference between the combining area and the other areas, and then adds the voltage compensation value to the second power source high potential signal to obtain the first power source high potential signal.

In the backlight module of the present disclosure, the driving chip is configured for calculating the corresponding voltage compensation value according to the brightness difference between the combining area and the other areas, and then adds the voltage compensation value to the second power source high potential signal to obtain the first power source high potential signal.

In the backlight module of the present disclosure, the backplane further comprises a backlight driving circuit for driving the light emitting units to emit light; wherein the backlight driving circuit comprises:

a data signal input module, configured for inputting data signals under control of scan signals;

a driving module, connected with the data signal input module, the driving module is configured for driving the light emitting units to emit light under control of the data signals and the power source high potential signals; and

a storage module, connected with the data signal input module and the driving module, the storage module is configured for storage of the data signals.

In the backlight module of the present disclosure, the light emitting units comprises a plurality of Mini LEDs that are connected in series.

The present disclosure also provides a display device, comprising a liquid crystal display panel and a backlight module; wherein the backlight module comprises a plurality of backplanes that are combined; wherein a plurality of light emitting units are disposed on the backplane in an array, the light emitting units are configured for emitting light under control of power source high potential signals and power source low potential signals; wherein the light emitting units include first light emitting units that are located in a combining area of adjacent backplanes and second light emitting units that are located in other areas of the backplanes; wherein on at least one of the backplanes, intensity of first power source high potential signals corresponding to the first light emitting units is greater than that of second power source high potential signals corresponding to the second light emitting units.

In the display device of the present disclosure, for two adjacent backplanes, the intensity of the first power source high potential signals, corresponding to any one of the backplanes is greater than that of the second power source high potential signals corresponding to the same backplane.

In the display device of the present disclosure, for two adjacent backplanes, the intensity of the first power source high potential signals corresponding to one of the two backplanes is greater than that of the second power source high potential signals corresponding to the same backplane, and the intensity of the first power source high potential signals corresponding to the other backplane is equal to that of the second power source high potential signals corresponding to the same backplane.

In the display device of the present disclosure, on the backplanes, the intensity of the power source low potential signals corresponding to each of the light emitting units, respectively, are equal.

In the display device of the present disclosure, the plurality of backplanes are each connected with a corresponding driving chip that input the first power source high potential signals and the second power source high potential signals to the light emitting units.

In the display device of the present disclosure, the driving chip is configured for querying a corresponding voltage compensation value from a locally stored voltage compensation comparison table according to a brightness difference between the combining area and the other areas, and then adds the voltage compensation value to the second power source high potential signal to obtain the first power source high potential signal.

In the display device of the present disclosure, the driving chip is configured for calculating the corresponding voltage compensation value according to the brightness difference between the combining area and the other areas, and then adds the voltage compensation value to the second power source high potential signal to obtain the first power source high potential signal.

In the display device of the present disclosure, the backplane further comprises a backlight driving circuit for driving the light emitting units to emit light; wherein the backlight driving circuit comprises:

a data signal input module, configured for inputting data signals under control of scan signals;

a driving module, connected with the data signal input module, the driving module is configured for driving the light emitting units to emit light under control of the data signals and the power source high potential signals; and

a storage module, connected with the data signal input module and the driving module, the storage module is configured for storage of the data signals.

In the display device of the present disclosure, the light emitting units comprises a plurality of Mini LEDs that are connected in series.

### Beneficial Effects

The beneficial effects of the present disclosure are as follows: The present disclosure provides a backlight module and a display device having same. The backlight module comprises a plurality of photo sensing circuits and a plurality of location sensing circuits. Wherein the plurality of photosensing circuits are arranged in the backlight module in an array, and wherein the photosensing circuits each comprises a photosensing transistor. Wherein the photosensing transistor comprises a substrate, a metal oxide active layer, a gate electrode layer, a source electrode layer, and a quantum dots layer. The quantum dots layer is in contact with the metal oxide active layer and is used for absorbing interactive light emitted by an interactive light source. A wavelength of the interactive light is greater than a maximum absorbing wavelength of the metal oxide active layer. The photosensing transistor is used for converting light intensity signals of the interactive light into electrical signals. The location sensing circuits are electrically connected with the photosensing circuits in order to determine the location where the interactive light irradiates according to the electrical signals. In the present disclosure, by disposing the quantum dots layer that is in contact with the metal oxide active layer in the photosensing transistor, the interactive light in long wavelengths may be absorbed, and the light intensity signals of absorbed light may be converted into the electrical signals. The location which the interactive light irradiates may be then determined by the location sensing circuits. Therefore, the interaction with the light in long wavelengths may be achieved, thereby solving the technical problem of a narrow range of wavelengths of the interactable light in the prior art.

### DESCRIPTION OF DRAWINGS

In order to clearly illustrate the embodiments of the present disclosure, the following briefly introduces the accompanying drawings used in the embodiments or description of prior arts. Obviously, the drawings in the following description merely show some of the embodiments of the present disclosure. As regards one of ordinary skill in the art, other drawings may be obtained in accordance with these accompanying drawings without making creative efforts.

FIG. 1 is a schematic diagram of a first input means of power source high potential signals in backlight module provided by the embodiments of the present disclosure;

FIG. 2 is a schematic diagram of a second input means of the power source high potential signals in the backlight module provided by the embodiments of the present disclosure;

FIG. 3 is a structural schematic view of a backlight driving circuit in the backlight module provided by the present disclosure; and

FIG. 4 is a structural schematic view of a display device provided by the present disclosure.

### DETAILED DESCRIPTION OF PREFERRED EMBODIMENTS

The following description of the embodiments with reference to the accompanying drawings is used to illustrate particular embodiments of the present disclosure. The directional terms referred in the present disclosure, such as “upper”, “lower”, “front”, “back”, “left”, “right”, “inner”, “outer”, “side surface”, etc. are only directions with regard to the accompanying drawings. Therefore, the directional terms used for describing and illustrating the present disclosure are not intended to limit the present disclosure. In the drawings, units with similar structures are indicated by the same reference number.

The present disclosure provides a backlight module and a display device having same for overcoming a technical problem of having a lower brightness in combining areas in conventional mini-LED backlight modules.

The present disclosure provides the backlight module, comprising a plurality of backplanes that are combined. Wherein a plurality of light emitting units are disposed on the backplane for emitting light under control of power source high potential signals and power source low potential signals. Wherein the light emitting units include first light emitting units that are located in a combining area of adjacent backplanes and second light emitting units that are located in other areas of the backplanes. Wherein on at least one of the backplanes, intensity of first power source high potential signals corresponding to the first light emitting units is greater than that of second power source high potential signals corresponding to the second light emitting units.

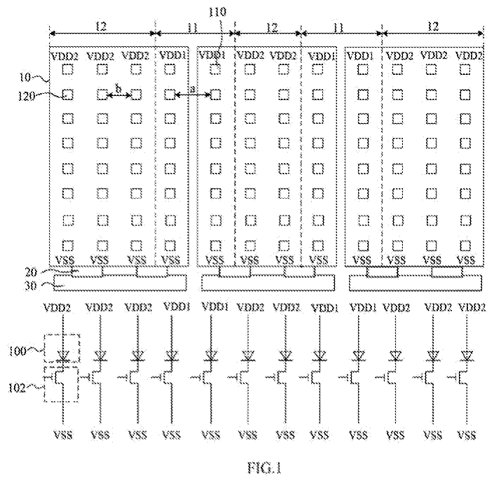

As shown in FIG. 1, the backlight module of the present disclosure provides backlight for medium-size or large-size liquid crystal display panels. The backlight module is formed by combining a plurality of backplanes 10. A plurality of light emitting units 100 are disposed on the backplanes 10 in an array. Further, each of the light emitting units 100 may comprise a plurality of mini LEDs or micro LEDs that are connected in series. A backlight driving circuit in each of the backplanes 10 individually drives each of the light emitting units 100 on the backplane 10, thereby individually controlling light emission of each of the light emitting units 100, and thereby individually providing backlight for pixels within each partition of the liquid crystal display panel. Compared with backlight modules adopting whole-screen driving, backlight modules adopting multi-partition driving are more agile in brightness control, and therefore have better light emitting effect.

The light emitting units 100 located within combining areas 11 of adjacent backplanes 10 are first light emitting units 110, and the light emitting units 100 located within other areas 12 are second light emitting units 120. Because the backlight module is formed by combining the plurality of backplanes 10, and due to the limitations of manufacturing processes, in two adjacent backplanes 10, an interval a between two rows of first light emitting units 110 which are located in the combining area 11 are larger than an interval b between any two adjacent rows of the second light emitting units 120 which are located in the other areas 12. Therefore, when light emission intensity of the first light emitting units 110 and a light emission intensity of the second light emitting units 120 is the same, an overall brightness after light mixing in different rows of the first light emitting units 110 in the combining area 11 is low, an overall brightness after light mixing in different rows of the second light emitting units 120 of the other areas 12 is high, and seam shadows thus appear in the combining area 11. The seam shadows affect the display effect of the liquid crystal display panel when backlight is provided for liquid crystal display panel.

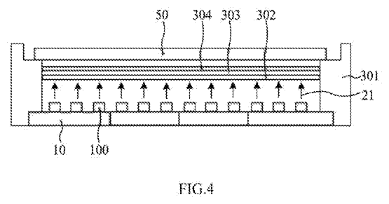

As shown in FIG. 3, the backlight 10 comprises the plurality of light emitting units 100 that are disposed in an array. All of the plurality of light emitting units 100 are driven by the backlight driving circuit. The backlight driving circuit comprises a data signal input module 101, a driving module 102, and a storage module 103. The data signal input module 101 is configured for inputting data signals,

Data, under control of scan signals, Scan. The driving module 102 is connected with the data signal input module 101 and is configured for driving the light emitting units 100 to emit light under control of the data signals, Data, and power source high potential signals, VDD. The storage module 103 is connected with the data signal input module 101, and the driving module 102 and is configured for the storage of the data signals Data.

Specifically, the data signal input module 101 comprises a switch transistor, T2, the driving module 102 comprises a driving transistor, T1, and the storage module 103 comprises a storage capacitor, Cs. A gate electrode of the switch transistor, T2 is inputted with the scan signals Scan and a first electrode of the switch transistor, T2 is inputted with the data signals, Data. A second electrode of the switch transistor, T2 is connected with a gate electrode of the driving transistor T1 and with a first electrode plate of the storage capacitor, Cs. A second electrode plate of the storage capacitor, Cs, is grounded. A first electrode of the driving transistor, T1, is inputted with the power source high potential signals, VDD, and a second electrode of the driving transistor T1 is inputted with the power source low potential signals, VSS.

Working stages of the light emitting unit 100 include a data writing stage, t1, and a light emitting stage, t2. During the date writing stage tl, the scan signals Scan are at high electrical potential, and the switch transistor, T2, is switched on. The data signals, Data, are transmitted to the gate electrode of the driving transistor, T1, and are stored in the storage capacitor, Cs. The driving transistor, T1, is switched on, and thus makes the light emitting unit 100 to emit light. During the light emitting stage, t2, the scan signals Scan are at low electrical potential, the switch transistor, T2, is switched off, and a gate electrode potential that drives the transistor, T1, may be maintained by the storage capacitor, Cs, thereby making the light emitting unit 100 to continue emitting light.

The light emission intensity of the light emitting unit 100 relates to a voltage difference between the power source high potential signals, VDD, and the power source low potential signals, VSS. The greater the voltage difference is, the greater the light emission intensity of the light emitting unit 100 is.

As shown in FIG. 1, in the present disclosure, first power source high potential signals, VDD1, are inputted to the backlight driving circuits corresponding to the first light emitting units 110 in the combining area 11 and second power source high potential signals, VDD2, are inputted to the backlight driving circuits corresponding to the second light emitting units 120 in the other areas 12. In addition, intensity of the first power source high potential signals, VDD1, corresponding to at least one of the backplanes 10 is greater than intensity of the second power source high potential signals, VDD2, corresponding to the same backplane(s) 10. Therefore, as to the said backplane(s) 10, the voltage difference between the intensity of the power source high potential signals, VDD, and that of the power source low potential signals, VSS, is greater in the combining area 11. Therefore, the light emission intensity of the corresponding first light emitting units 110 is greater than the light emission intensity of the second light emitting units 120, and thus the overall brightness of the first light emitting units 110 that have large intervals in the combining area 11 and the overall brightness of the second light emitting units 120 that have small intervals in the other areas 12 are made equal. Therefore, seam shadows are eliminated, and the display effect of display devices is enhanced.

In an embodiment, for two adjacent backplanes 10, the intensity of the first power source high potential signals, VDD1, corresponding to any one of the backplanes is greater than that of the second power source high potential signals VVD2 corresponding to the same backplane. Wherein, as shown in FIG. 1, the light emission intensity of two rows of the first light emitting units 100 in each of the combining areas, respectively, is increased. Therefore, the overall brightness of the combining area 11 is further enhanced, and therefore effect of eliminating the seam shadows is better. When the first power source high potential signals, VDD1, corresponding to the two backplanes 10, respectively, are equal, the light mixing effect is more uniformed, and the brightness is more effectively enhanced.

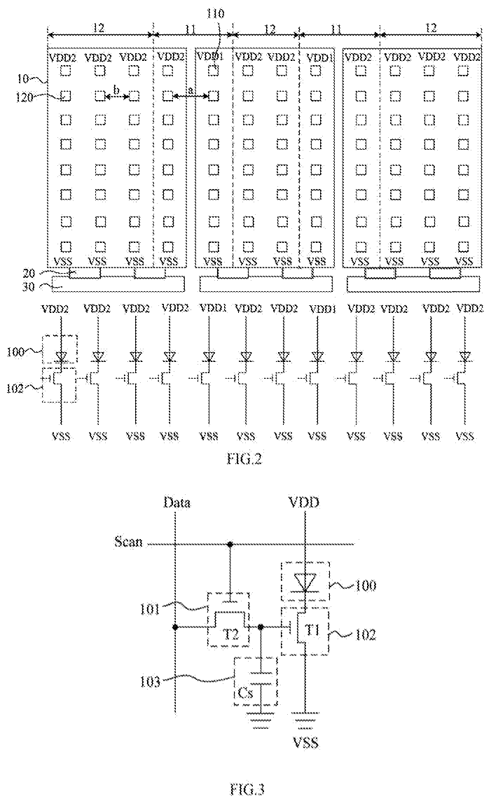

In an embodiment, for two adjacent backplanes 10, the intensity of the first power source high potential signals, VDD1, corresponding to one of the two backplanes 10 is greater than that of the second power source high potential signals, VDD2, corresponding to the same backplane, and the intensity of the first power source high potential signals, VDD1, corresponding to the other backplane is equal to that of the second power source high potential signals, VDD2, corresponding to the same backplane. As shown in FIG. 2, in which a combination of three backplanes is shown as an example, the intensity of the first power source high potential signals, VDD1, corresponding to a backplane 10 in the middle is greater than that of the second power source high potential signals, VDD2, corresponding to the same backplane, and the second power source high potential signals, VDD2, are inputted to the combining area 11 and the other areas 12 both of the backplane 10 on the left side and of the backplane 10 on the right side. That is, the intensity of the first power source high potential signals, VDD1, is equal to the intensity of the second power source high potential signals, VDD2. At the moment, in two rows of the light emitting units 110 on each of the combining areas 11, a brightness of one of the two rows of the light emitting units 110 remains unchanged, and a brightness of the other row of the light emitting units 110 is increased. Therefore, the overall brightness of the combining area 11 may be enhanced to a certain extent. In scenarios wherein a brightness difference between the combining area 11 and the other areas 12 is smaller, the brightness may be enhanced merely by increase the intensity of the first power high potential signals, VDD1, corresponding to one of the rows of the first light emitting units 110. Compared to the embodiment corresponding to FIG. 1, the method described in the present embodiment causes less increase in energy consumption, and therefore has lower costs.

As shown in FIG. 1 and FIG. 2, each of the plurality of backplanes 10 are connected with a corresponding driving chip 30 through a printed circuit board 20, respectively. On each backplane 10, a same row of the light emitting units 100 are connected to a same power source high potential signal wire that inputs the same power source high potential signals, VDD, to every light emitting unit 100 of the corresponding row. Therefore, a change in the light emission intensity of the first light emitting units 110 is always carried out on a row basis.

In addition, in the backplane 10, the intensity of the power source low potential signals, VSS, corresponding to each light emitting units 100, respectively, are equal. Therefore, the voltage difference between the power source high potential signals, VDD, and power source low potential signals, VSS, may be increased, and the brightness of the corresponding light emitting units 100 may thus be increased, merely by changing a value of the power source high potential signals, VDD.

On each backplane 10, each row of the light emitting units 100 are correspondingly connected with the power source high potential signal wire. Corresponding power source high potential signals, VDD, in each of the power source high potential signal wires are provided by the driving chip 30 connected with the backplane 10. That is, the driving chip 30 inputs the first power source high potential signals, VDD1, and the second power source high potential signals, VDD2, to the light emitting units 100. There may be two ways to determine a specific value of the first power source high potential signals, VDD1.

In an embodiment, the driving chip 30 is configured for querying a corresponding voltage compensation value from a locally stored voltage compensation comparison table according to the brightness difference between the combining area 11 and the other areas 12, and then adds the voltage compensation value to the second power source high potential signal, VDD2, to obtain the first power source high potential signal, VDD1. The voltage compensation comparison table has been stored in the driving chip 30 in advanced. The table includes a plurality of brightness values or brightness ranges. For each of the plurality of brightness values or brightness ranges, there is a corresponding voltage compensation value. After the brightness difference between the combining area 11 and the other areas 12 is obtained, and the corresponding voltage compensation value is found in the voltage compensation comparison table, the corresponding voltage compensation value is added to the value of the second power source high potential signal, VDD2. The added value is inputted to the first light emitting units 110, thereby, the light emission intensity of the first light emitting units 110 may be increased, and the increased portion of the brightness is just enough to compensate the aforementioned brightness difference. It is more convenient and faster to obtain the voltage compensation values by querying the values from the table.

In an embodiment, the driving chip 30 is configured for calculating the corresponding voltage compensation value according to the brightness difference between the combining area 11 and the other areas 12, and then adds the voltage compensation value to the second power source high potential signal, VDD2, to obtain the first power source high potential signal, VDD1. For each of the plurality of brightness values or brightness ranges, there is a corresponding voltage compensation value. After the brightness difference between the combining area 11 and the other areas 12 is obtained and the corresponding voltage compensation value is calculated by the driving chip 30, the voltage compensation value is added to the value of the second power source high potential signal, VDD2. The added value is inputted to the first light emitting units 110, thereby the light emission intensity of the first light emitting units 110 may be increased, and the increased portion of the brightness is just enough to compensate the aforementioned brightness difference. It is more accurate to obtain the voltage compensation value by calculation.

In the present disclosure, by aforementioned means, the intensity of the first power source high potential signals, VDD1, is set to be greater than that of the second power source high potential signals, VDD2, so the difference between the intensity of the power source high potential signals, VDD, and that of the power source low potential signals, VSS, is greater in the combining areas 11. Therefore, the brightness of the corresponding first light emitting units 110 is greater than the brightness of the second light emitting units 120, and thus the overall brightness of the first light emitting units 110 in the combining area 11 that have large intervals and the overall brightness of the second light emitting units 120 in the other areas 12 that have small intervals are made equal. Therefore, the display effect of the display device is enhanced.

As shown in FIG. 4, the present disclosure also provides a display device, comprising a liquid crystal display panel 50 and a backlight module. The backlight module comprises a plurality of backplanes 10 that are combined, a sealant frame 301, a diffusion plate 302, a reflector 303, and an optical film 304. The plurality of light emitting units 100 are disposed on the backplane 10 in an array. The liquid crystal display panel 50 is fixed onto the sealant frame 301 of the backlight module by a bounding layer (not shown). In the backlight module, the light 21 emitted by the light emitting units 110 that are disposed on the backplane 201 reaches the liquid crystal display panel 50 after passing the diffusion plate 302, the reflector 303, and the optical film 304. The light 21 is first polarized by a lower polarizer of the liquid crystal display panel 50. The liquid crystal display panel 50 inputs data signal voltages with different values to each pixel by a switch function of TFTs. Liquid crystal molecules under different voltages have different rotation statuses, and therefore have different permeabilities to polarized light. Therefore, the brightness of the light that eventually exits from an upper polarizer is also different, thereby achieving image display of multiple grayscales.

In the display device of the present disclosure, the backlight module is the backlight module described in any one of the embodiments described hereinabove. By setting the intensity of the first power source high potential signals to be greater than the intensity of the second power source high potential signals, the difference between the intensity of the power source high potential signals and that of the power source low potential signals is made greater in the combining areas. Therefore, the brightness of the corresponding first light emitting units is greater than the brightness of the second light emitting units, and thus the overall brightness of the first light emitting units in the combining area that have large intervals and the overall brightness of the second light emitting units in the other areas that have small intervals are made equal. Therefore, the display effect of the display device is enhanced.

According to the aforementioned embodiments:

The present disclosure provides a backlight module and a display device having same. The backlight module comprises the plurality of backplanes that are combined. The plurality of light emitting units are disposed on the backplane in an array, the light emitting units are configured for emitting light under the control of power source high potential signals and power source low potential signals. Wherein, the light emitting units include the first light emitting units that are located in the combining area of adjacent backplanes and the second light emitting units that are located in the other areas of the backplanes. On at least one of the backplanes, the intensity of first power source high potential signals corresponding to the first light emitting units is greater than that of second power source high potential signals corresponding to the second light emitting units. In the present disclosure, by setting the intensity of the first power source high potential signals to be greater than the intensity of the second power source high potential signals, the difference between the power source high potential signals and the power source low potential signals is made greater in the combining areas. Therefore, the brightness of the corresponding first light emitting units is greater than the brightness of the second light emitting units, and thus the overall brightness of the first light emitting units in the combining area that have large intervals and the overall brightness of the second light emitting units in the other areas that have small intervals are made equal, thereby enhancing the display effect of display devices.

In the aforementioned embodiments, the description of each embodiment has its own emphasis. For a part that is not detailed in an embodiment, refer to related descriptions in other embodiments.

The backplane module and the display device having same provided in the embodiments of the present disclosure are described in detail above. Specific embodiments are used herein to explain the principles and implementation of the present disclosure. The above embodiments are used to assist in understanding the technical solutions and the core ideas of this disclosure. Those of ordinary skill in the art should understand that the technical solutions described in the foregoing embodiments can be modified, or some of the technical features can be replaced. These modifications and replacements do not substantially deviate the corresponding technical solutions from the scopes of the technical solutions of the embodiments of the present disclosure.

What is claimed is:

1. A backlight module, comprising a plurality of backplanes that are combined;
wherein a plurality of light emitting units are disposed on the backplane in an array, the light emitting units are configured for emitting light under control of power source high potential signals and power source low potential signals;
wherein the light emitting units include first light emitting units that are located in a combining area of adjacent backplanes and second light emitting units that are located in other areas of the backplanes; wherein on at least one of the backplanes, intensity of first power source high potential signals corresponding to the first light emitting units is greater than that of second power source high potential signals corresponding to the second light emitting units.

2. The backlight module as claimed in claim 1, wherein for two adjacent backplanes, the intensity of the first power source high potential signals, corresponding to any one of the backplanes is greater than that of the second power source high potential signals corresponding to the same backplane.

3. The backlight module as claimed in claim 2, wherein the intensity of the first power source high potential signals corresponding to the two backplanes are equal.

4. The backlight module as claimed in claim 1, wherein for two adjacent backplanes, the intensity of the first power source high potential signals corresponding to one of the two backplanes is greater than that of the second power source high potential signals corresponding to the same backplane, and the intensity of first power source high potential signals corresponding to the other backplane is equal to that of the second power source high potential signals corresponding to the same backplane.

5. The backlight module as claimed in claim 1, wherein on the backplanes, a same row of light emitting units are connected to a same power source high potential signal wire that inputs the same power source high potential signals to every light emitting unit of the corresponding row.

6. The backlight module as claimed in claim 1, wherein on the backplanes, the intensity of the power source low potential signals corresponding to each of the light emitting units, respectively, are equal.

7. The backlight module as claimed in claim 1, wherein the plurality of backplanes are each connected with a corresponding driving chip that input the first power source high potential signals and the second power source high potential signals to the light emitting units.

8. The backlight module as claimed in claim 7, wherein the driving chip is configured for querying a corresponding voltage compensation value from a locally stored voltage compensation comparison table according to a brightness difference between the combining area and the other areas, and then adds the voltage compensation value to the second power source high potential signal to obtain the first power source high potential signal.

9. The backlight module as claimed in claim 7, wherein the driving chip is configured for calculating the corresponding voltage compensation value according to the brightness difference between the combining area and the other areas, and then adds the voltage compensation value to the second power source high potential signal to obtain the first power source high potential signal.

10. The backlight module as claimed in claim 1, wherein the backplane further comprises a backlight driving circuit for driving the light emitting units to emit light; wherein the backlight driving circuit comprises:
a data signal input module, configured for inputting data signals under control of scan signals;
a driving module, connected with the data signal input module, the driving module is configured for driving the light emitting units to emit light under control of the data signals and the power source high potential signals; and
a storage module, connected with the data signal input module and the driving module, the storage module is configured for the storage of the data signals.

11. The backlight module as claimed in claim 1, wherein the light emitting units comprises a plurality of Mini LEDs that are connected in series.

12. A display device, comprising a liquid crystal display panel and a backlight module; wherein the backlight module comprises a plurality of backplanes that are combined;
wherein a plurality of light emitting units are disposed on the backplane in an array, the light emitting units are configured for emitting light under control of power source high potential signals and power source low potential signals;
wherein the light emitting units include first light emitting units that are located in a combining area of adjacent backplanes and second light emitting units that are located in other areas of the backplanes; wherein on at least one of the backplanes, intensity of first power source high potential signals corresponding to the first light emitting units is greater than that of second power source high potential signals corresponding to the second light emitting units.

13. The display device as claimed in claim 12, wherein for two adjacent backplanes, the intensity of the first power source high potential signals, corresponding to any one of the backplanes is greater than that of the second power source high potential signals corresponding to the same backplane.

14. The display device as claimed in claim 12, wherein for two adjacent backplanes, the intensity of the first power source high potential signals corresponding to one of the two backplanes is greater than that of the second power source high potential signals corresponding to the same backplane, and the intensity of the first power source high potential signals corresponding to the other backplane is equal to that of the second power source high potential signals corresponding to the same backplane.

15. The display device as claimed in claim 12, wherein on the backplanes, the intensity of the power source low potential signals corresponding to each of the light emitting units, respectively, are equal.

16. The display device as claimed in claim 12, wherein the plurality of backplanes are each connected with a corresponding driving chip that input the first power source high potential signals and the second power source high potential signals to the light emitting units.

17. The display device as claimed in claim 16, wherein the driving chip is configured for querying a corresponding voltage compensation value from a locally stored voltage compensation comparison table according to a brightness difference between the combining area and the other areas, and then adds the voltage compensation value to the second power source high potential signal to obtain the first power source high potential signal.

18. The display device as claimed in claim 16, wherein the driving chip is configured for calculating the corresponding voltage compensation value according to the brightness difference between the combining area and the other areas, and then adds the voltage compensation value to the second power source high potential signal to obtain the first power source high potential signal.

19. The backlight module as claimed in claim 12, wherein the backplane further comprises a backlight driving circuit for driving the light emitting units to emit light; wherein the backlight driving circuit comprises:
a data signal input module, configured for inputting data signals under control of scan signals;
a driving module, connected with the data signal input module, the driving module is configured for driving the light emitting units to emit light under control of the data signals and the power source high potential signals; and
a storage module, connected with the data signal input module and the driving module, the storage module is configured for the storage of the data signals.

20. The backlight module as claimed in claim 12, wherein the light emitting units comprises a plurality of Mini LEDs that are connected in series.
